(19) United States
(12) Patent Application Publication
(10) Pub. No.: US 2026/0121247 A1
(43) Pub. Date: Apr. 30, 2026

(54) SECONDARY BATTERY

(71) Applicant: SAMSUNG SDI CO., LTD., Yongin-si (KR)

(72) Inventor: Dong Bok YANG, Yongin-si (KR)

(21) Appl. No.: 19/008,462

(22) Filed: Jan. 2, 2025

(30) Foreign Application Priority Data
Jul. 17, 2024 (KR) 10-2024-0094157

(51) Int. Cl. H01M 50/533; H01M 50/586

(52) U.S. Cl. CPC H01M 50/533; H01M 50/586

(57) ABSTRACT

A secondary battery according to the embodiment includes a case; and an electrode assembly accommodated in the case, the case includes an accommodation part and a cap part, the accommodation part and the cap part are coupled by a sealing layer, the electrode assembly includes a first electrode, a second electrode, and a separator, the first electrode and the second electrode include electrode tabs, the electrode tabs are connected to a lead that is connectable to an external terminal, the lead includes a first region and a second region, a size of the first region is smaller than a size of the second region, and the first region overlaps with the sealing layer.

### CROSS-REFERENCE TO RELATED APPLICATION

The present application claims priority to and the benefit of Korean Patent Application No. 10-2024-0094157, filed on Jul. 17, 2024 in the Korean Intellectual Property Office, the entire disclosure of which is incorporated herein by reference.

### BACKGROUND

### 1. Field

Aspects of embodiments of the present disclosure relate to a secondary battery.

### SUMMARY

According to an aspect of embodiments of the present disclosure, a secondary battery having improved safety is provided.

According to one or more embodiments, a secondary battery comprises a case; and an electrode assembly accommodated in the case, the case comprises an accommodation part and a cap part, the accommodation part and the cap part are coupled by a sealing layer, the electrode assembly comprises a first electrode, a second electrode, and a separator, the first electrode and the second electrode comprise electrode tabs, the electrode tabs are connected to a lead that is connectable to an external terminal, the lead comprises a first region and a second region, a size of the first region is smaller than a size of the second region, and the first region overlaps with the sealing layer.

In one or more embodiments, a minimum width of the first region is smaller than a width of the second region.

In one or more embodiments, a thickness of the first region is smaller than a thickness of the second region.

In one or more embodiments, a length of the first region is smaller than a length of the second region.

In one or more embodiments, a length of the first region is 5% to 10% of a length of the lead.

In one or more embodiments, the lead comprises a first end and a second end, and a width of the first region varies along a direction from the first end toward the second end.

In one or more embodiments, the lead comprises a first end and a second end, and a thickness of the first region varies along a direction from the first end toward the second end.

In one or more embodiments, the first region comprises a 1-1 region and a 1-2 region, and a minimum width of the 1-1 region and a minimum width of the 1-2 region are smaller than a width of the second region.

In one or more embodiments, lengths of the 1-1 region and the 1-2 region are different.

In one or more embodiments, the 1-2 region is located closer to the electrode assembly than the 1-1 region, and a length of the 1-2 region is smaller than a length of the 1-1 region.

In one or more embodiments, a minimum width of the 1-1 region is greater than a minimum width of the 1-2 region.

In one or more embodiments, the 1-2 region is located closer to the electrode assembly than the 1-1 region.

In one or more embodiments, the first region comprises a 1-1 region and a 1-2 region, and a thickness of the 1-1 region and a thickness of the 1-2 region are smaller than a thickness of the second region.

In one or more embodiments, the 1-2 region is located closer to the electrode assembly than the 1-1 region, and a length of the 1-2 region is smaller than a length of the 1-1 region.

In one or more embodiments, a thickness of the 1-1 region is greater than a thickness of the 1-2 region.

In one or more embodiments, the 1-2 region is located closer to the electrode assembly than the 1-1 region.

In one or more embodiments, an entirety of the first region overlaps with the sealing layer.

In one or more embodiments, a portion of the first region overlaps with the sealing layer.

In one or more embodiments, the secondary battery further comprises an insulating layer around (e.g., surrounding) the lead, and the first region entirely or partially overlaps with the insulating layer.

### BRIEF DESCRIPTION OF THE DRAWINGS

FIG. 1 is a perspective view showing a secondary battery according to an embodiment.

FIGS. 2A and 2B are top views showing a lead of the secondary battery according to an embodiment.

FIG. 3 is a top view showing the secondary battery according to the embodiment.

FIG. 4 is a cross-sectional view taken along the line A-A′ of FIG. 3.

FIG. 5 is a top view showing the lead of the secondary battery according to an embodiment.

FIGS. 6A to 6C are views explaining overlapping of the lead and a sealing layer of the secondary battery according to an embodiment.

FIG. 7 is a top view showing the lead of the secondary battery according to another embodiment.

FIG. 8 is a cross-sectional view taken along the line B-B′ of FIG. 7.

FIGS. 9A and 9B are top views showing the lead of the secondary battery according to another embodiment.

FIG. 10 is a top view showing the lead of the secondary battery according to another embodiment.

FIG. 11 is a cross-sectional view taken along the line C-C′ of FIG. 10.

FIG. 12 is a top view showing the lead of the secondary battery according to another embodiment.

FIG. 13 is a top view showing the lead of the secondary battery according to another embodiment.

FIG. 14 is a cross-sectional view taken along the line D-D′ of FIG. 13.

FIG. 15 is a top view showing the lead of a secondary battery according to another embodiment.

FIG. 16 is a top view showing the lead of the secondary battery according to another embodiment.

FIG. 17 is a cross-sectional view taken along the line E-E′ of FIG. 16.

FIGS. 18 and 19 are perspective views showing a battery pack including battery modules according to some embodiments.

FIGS. 20 and 21 are a perspective view and a side view, respectively, showing a vehicle including battery packs according to some embodiments.

### DETAILED DESCRIPTION

Herein, a secondary battery according to an embodiment will be described with reference to the drawings. The secondary battery may be classified as a cylindrical shape, a prismatic shape, a pouch shape, or a coin shape depending on a shape thereof. The secondary battery described below may be applied to a pouch-type secondary battery, for example.

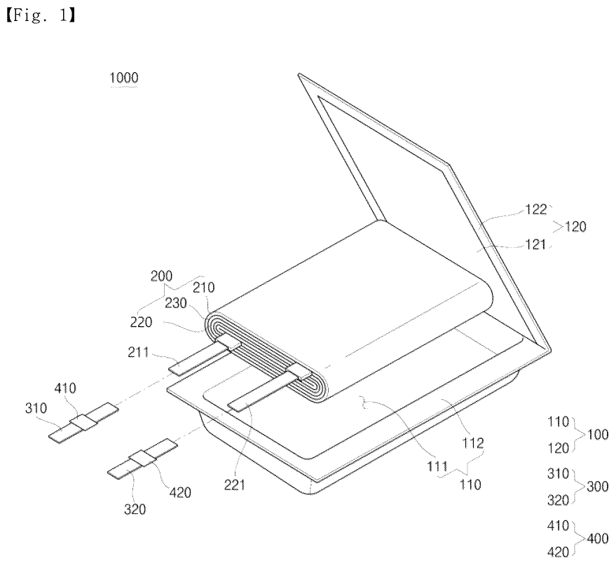

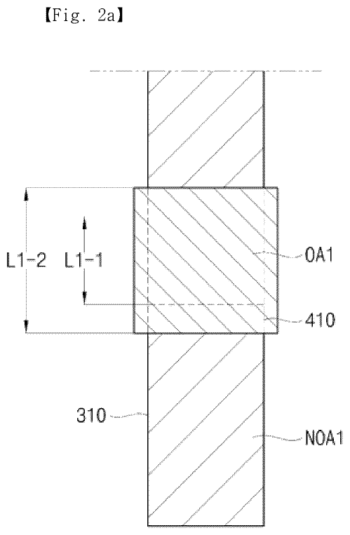

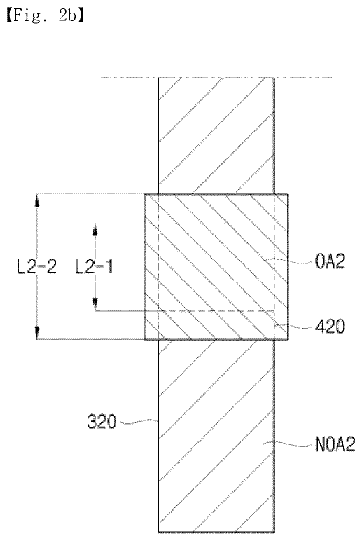

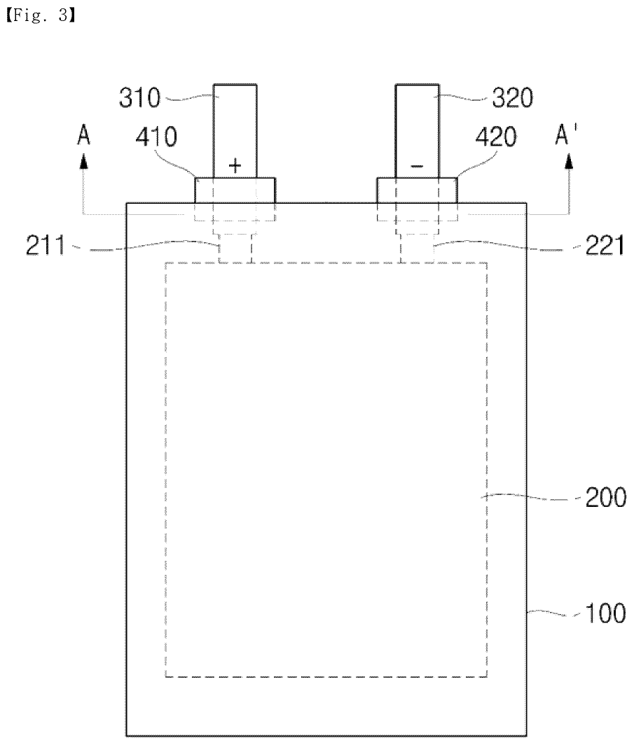

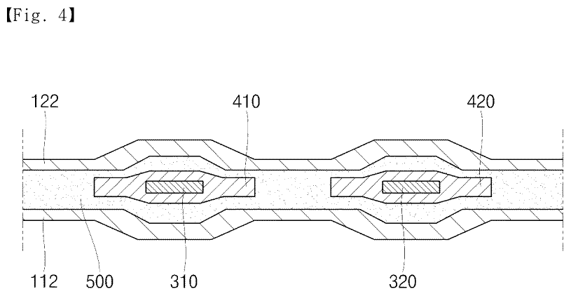

Referring to FIGS. 1 to 4, a secondary battery 1000 according to an embodiment may include a case 100 and an electrode assembly 200.

The case 100 may include an accommodation part 110 and a cap part 120. The accommodation part 110 and the cap part 120 may be connected. The case 100 may be formed in a pouch shape.

The accommodation part 110 may include a concave part 111 and a first sealing region 112. The accommodation part 110 may include an accommodation space. In an embodiment, the accommodation part 110 may include an internal bottom surface and an inner side surface formed by the concave part 111. The accommodation space may be formed by, or defined by, the bottom surface and the inner side surface.

The first sealing region 112 may be disposed at the edge of the accommodation part 110. A sealing layer may be disposed on the first sealing region 112.

The cap part 120 may include a cover part 121 and a second sealing region 122.

The cover part 121 may cover the accommodation part 110. The cover part 121 may cover the electrode assembly 200 accommodated in the accommodation part 110.

The second sealing region 122 may be disposed at the edge of the cap part 120. The sealing layer may be disposed on the second sealing region 122. The first sealing region 112 and the second sealing region 122 may overlap with each other. If the accommodation part 110 is covered by the cap part 120, the first sealing region 112 and the second sealing region 122 may face each other.

The electrode assembly 200 may be accommodated in the case 100. The electrode assembly 200 may be accommodated inside the accommodation space of the case. The electrode assembly 200 may be accommodated inside the accommodation space together with the electrolyte.

In the drawings, one electrode assembly is shown accommodated in the case. However, embodiments are not limited thereto, and two or more electrode assemblies may be accommodated in the case.

The electrode assembly 200 may include a first electrode 210, a second electrode 220, and a separator 230. The electrode assembly 200 may be formed by winding or laminating the first electrode 210, the second electrode 220, and the separator 230. If the electrode assembly 200 has a winding shape, the winding axis may be parallel to the Y axis direction. In another embodiment, the electrode assembly may be a Z-stack electrode assembly in which the first electrode 210 and the second electrode 220 are inserted on both, or opposite, sides of a separator 230 bent into a Z-stack.

The first electrode 210 may include a first electrode current collector and a first electrode active material layer. The first electrode current collector may include a metal foil, such as aluminum or an aluminum alloy. In an embodiment, the first electrode active material layer may include a transition metal oxide. For example, the first electrode 210 may be a positive electrode.

The first electrode 210 may include a first electrode tab 211. The first electrode active material layer is not disposed on the first electrode tab 211. In an embodiment, the first electrode tab 211 may be welded to the first electrode current collector. In another embodiment, the first electrode tab 211 may be formed integrally with the first electrode current collector. For example, the first electrode current collector may include a first uncoated portion on which the first electrode active material layer is not disposed. The first uncoated portion may be the first electrode tab 211. In an embodiment, the first electrode tab 211 may include a same material as the first electrode current collector.

The second electrode 220 may include a second electrode current collector and a second electrode active material layer. The second electrode current collector may include a metal foil, such as copper, a copper alloy, nickel, or a nickel alloy. In an embodiment, the second electrode active material layer may include graphite or carbon. For example, the second electrode 220 may be a negative electrode.

The second electrode 220 may include a second electrode tab 221. The second electrode active material layer is not disposed on the second electrode tab 221. In an embodiment, the second electrode tab 221 may be welded to the second electrode current collector. In another embodiment, the second electrode tab 221 may be formed integrally with the second electrode current collector. For example, the second electrode current collector may include a second uncoated portion on which the second electrode active material layer is not disposed. The second uncoated portion may be the second electrode tab 221. In an embodiment, the second electrode tab 221 may include a same material as the second electrode current collector.

The first electrode tab 211 and the second electrode tab 221 may each be connected to a lead. For example, the first electrode tab 211 may be connected to the first lead 310. The first electrode tab 211 may be connected to the first external terminal by the first lead 310. The second electrode tab 221 may be connected to the second lead 320. The second electrode tab 221 may be connected to the second external terminal by the second lead 320. In an embodiment, the first lead 310 may include a same material as the first electrode tab, and the second lead 320 may include a same material as the second electrode tab.

The first lead 310 may include a first overlapping area OA1 and a first non-overlapping area NOA1. The first overlapping area OA1 may have a 1-1 length L1-1. The first overlapping area OA1 may overlap with the case 100. The first overlapping area OA1 may overlap with the first sealing region 112 and the second sealing region 122. The first non-overlapping area NOA1 does not overlap with the first sealing region 112 and the second sealing region 122.

A first insulating layer 410 may be disposed on the first lead 310. For example, the first insulating layer 410 may be disposed on the first overlapping area OA1. In an embodiment, the first insulating layer 410 may surround the first lead 310. For example, the first insulating layer 410 may be disposed on an upper surface, a lower surface, and side surfaces of the first lead on the first overlapping area OA1.

The first insulating layer 410 may be disposed with a 1-2 length L1-2. The 1-2 length L1-2 may be longer than the 1-1 length L1-1. That is, the first insulating layer 410 may be disposed in the first overlapping area OA1 and a portion of the first non-overlapping area NOA1. Accordingly, in an embodiment, the first insulating layer 410 may be disposed while covering the entire first overlapping area OA1.

Therefore, the first lead 310 may be insulated from the case 100 by the first insulating layer 410, and the first lead 310 and the case 100 including different materials may be easily coupled by the first insulating layer 410. That is, the first insulating layer 410 may function as a buffer layer or an adhesive layer.

The second lead 320 may include a second overlapping area OA2 and a second non-overlapping area NOA2. The second overlapping area OA2 may have a 2-1 length L2-1. The second overlapping area OA2 may overlap with the case 100. The second overlapping area OA2 may overlap with the first sealing region 112 and the second sealing region 122. The second non-overlapping area NOA2 does not overlap with the first sealing region 112 and the second sealing region 122.

A second insulating layer 420 may be disposed on the second lead 320. For example, the second insulating layer 420 may be disposed on the second overlapping area OA2. In an embodiment, the second insulating layer 420 may surround the second lead 320. For example, the second insulating layer 420 may be disposed on an upper surface, a lower surface, and side surfaces of the second lead on the second overlapping area OA2.

The second insulating layer 420 may be disposed with a 2-2 length L2-2. The 2-2 length L2-2 may be longer than the 2-1 length L2-1. That is, the second insulating layer 420 may be disposed in the second overlapping area OA2 and a portion of the second non-overlapping area NOA2. Accordingly, in an embodiment, the second insulating layer 420 may be disposed to cover the entire second overlapping area OA2.

Therefore, the second lead 320 may be insulated from the case 100 by the second insulating layer 420, and the second lead 320 and the case 100 including different materials may be easily coupled by the second insulating layer 420. That is, the second insulating layer 420 may function as a buffer layer or an adhesive layer.

The secondary battery may flow a current exceeding an allowable current range due to overcharge or malfunction. The current may be transmitted to the electrode assembly along the lead and the electrode tab. Accordingly, the electrode assembly may be heated by the overcurrent. Accordingly, an internal temperature of the secondary battery may increase. If the electrode assembly is exposed to a high-temperature environment for a long time, the electrolyte may vaporize and generate gas, and an internal pressure of the secondary battery may increase due to the gas. Accordingly, a fire may occur in the secondary battery.

According to embodiments of the present disclosure, however, the above problem may be avoided by a shape of the lead.

The description of the lead described below may be applied to at least one of the first lead 310 and the second lead 320.

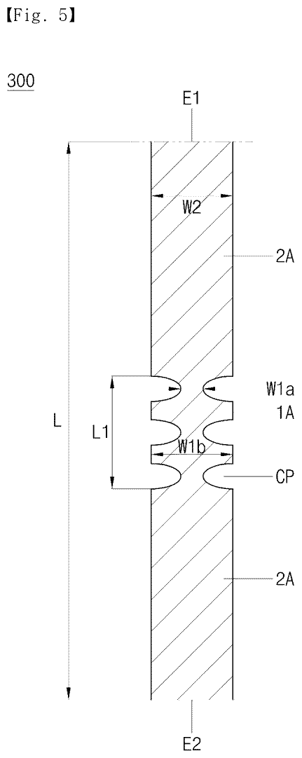

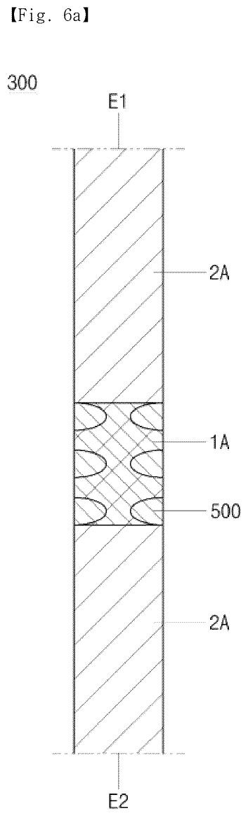

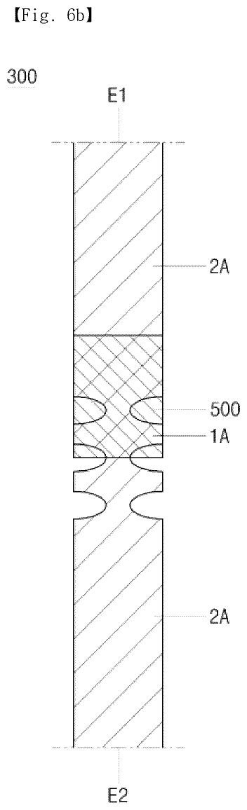

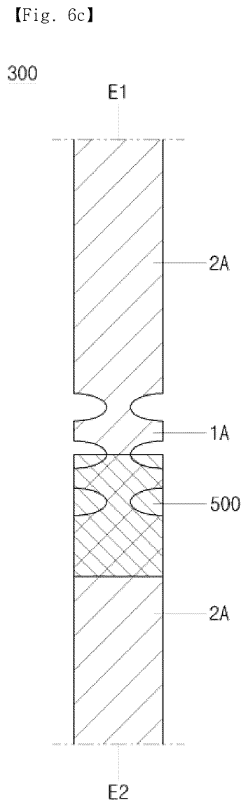

FIGS. 5 and 6A to 6C are top views viewing the lead according to an embodiment.

Referring to FIGS. 5 and 6A to 6C, the lead 300 may include a plurality of regions. For example, the lead may include a first region 1A and a second region 2A.

The first region 1A may be formed in a region of the lead. For example, the lead may include a first end E1 and a second end E2. The first end E1 may be connected to an external terminal. The second end E2 may be connected to the electrode tab. That is, the second end E2 may be closer to the electrode assembly 200 than the first end E1.

The first region 1A may be disposed between the first end E1 and the second end E2. For example, the first region 1A may be disposed between a pair of second regions 2A.

A size of the first region 1A may be smaller than a size of the second region 2A.

In an embodiment, the first region 1A may include a cutting part CP. For example, the first region 1A may include at least one cutting part CP. The cutting part CP is a region where the electrode tab is removed. Accordingly, a width of the first region 1A may vary.

In further detail, the first region 1A may have a 1a width W1a and a 1b width W1b. The second region 2A may have a 2 width W2.

The 1a width W1a and the 2 width W2 may be different. The 1a width W1a may be smaller than the 2 width W2. The 1b width W1b and the 2 width W2 may be the same or similar. That is, the 1a width W1a may be a minimum width of the first region 1A, and the 1b width W1b may be a maximum width of the first region 1A.

That is, the first region 1A may be formed as a region of which a width is reduced by the cutting part CP. Accordingly, it is possible to block an overcurrent from being transmitted to the electrode assembly. If an overcurrent flows from the outside to the secondary battery, the lead may be short-circuited by the first region 1A. That is, the width of the first region 1A is narrower than the width of the second region 2A. Accordingly, if an overcurrent flows through the electrode tab, the first region 1A may be heated (e.g., instantly heated) by the resistance of the lead due to the overcurrent. Accordingly, the lead may be cut off at the first region 1A. Accordingly, the overcurrent may be prevented or substantially prevented from being transmitted to the electrode assembly. Accordingly, heating of the electrode assembly may be prevented or substantially prevented. Accordingly, a fire of the secondary battery may be prevented or substantially prevented. Accordingly, the secondary battery according to the embodiment may have improved safety.

Sizes of the first region 1A and the second region 2A may be different. For example, lengths of the first region 1A and the second region 2A may be different. The first region 1A may have a first length L1. The second region 2A may have a second length. The first length L1 may be smaller than the second length. For example, the first length L1 may be smaller than a sum of the second lengths.

In an embodiment, the first length L1 may be 10% or less of a length L of the lead. In an embodiment, the first length L1 may be 5% to 10%, 6% to 9%, or 7% to 8% of the length L of the lead.

If the first length L1 exceeds 10% of the length L of the lead, a strength of the lead may decrease. Accordingly, the lead may break during a process of welding the lead. If the first length L1 is less than 5% of the length L of the lead, the size of the first region 1A decreases. Accordingly, when an overcurrent flows through the lead, the lead may not be cut off. Accordingly, an overcurrent may be transmitted to the electrode assembly, causing a fire in the secondary battery.

Referring to FIGS. 6A to 6C, in an embodiment, the first region 1A may be disposed in a set region. In an embodiment, the first region 1A may be entirely or partially overlapped with the sealing layer 500. The sealing layer 500 is disposed between the first sealing region 112 and the second sealing region 122 of the case, and the first region 1A may be entirely or partially overlapped with the insulating layers 410 and 420.

Referring to FIG. 6A, in an embodiment, the first region 1A may be entirely overlapped with the sealing layer 500. In other embodiments, referring to FIGS. 6B and 6C, the first region 1A may be partially overlapped with the sealing layer 500.

For example, referring to FIG. 6B, a portion of the first region may overlap with the sealing layer 500, and another portion may not overlap with the sealing layer 500. For example, another portion of the first region may be disposed inside the case 100.

Referring to FIG. 6C, a portion of the first region may overlap with the sealing layer 500, and another portion may not overlap with the sealing layer 500. For example, another portion of the first region may be disposed outside the case 100.

The first region 1A includes a narrow portion. Accordingly, the lead may be short-circuited by an external impact, for example. Accordingly, a defect in the secondary battery may occur when the secondary battery is normally operated. Since the first region 1A overlaps with the sealing layer 500, the first region 1A may be fixed by the sealing layer 500. Therefore, the first region 1A may be prevented or substantially prevented from being damaged by external impact. Therefore, the reliability of the secondary battery may be improved.

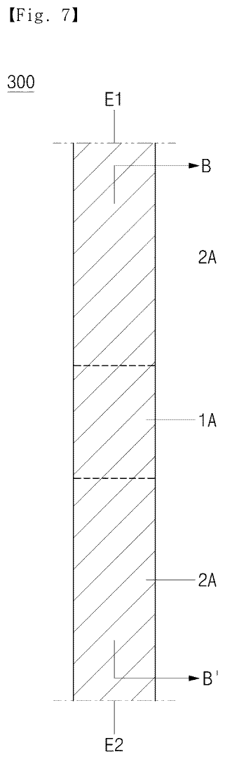

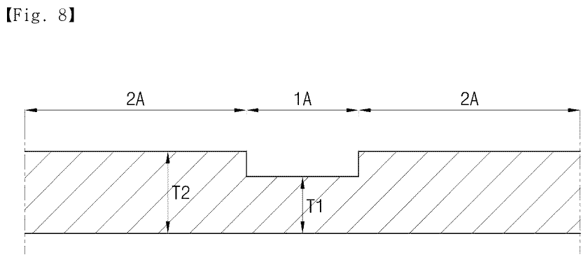

Referring to FIGS. 7 and 8, the first region 1A may have various shapes.

In an embodiment, the first region 1A and the second region 2A may have same or similar widths. In an embodiment, the first region 1A and the second region 2A may have different thicknesses.

The first region 1A may have a first thickness T1. The second region 2A may have a second thickness T2. The first thickness T1 may be smaller than the second thickness T2.

Accordingly, if an overcurrent flows from the outside to the secondary battery, the lead may be short-circuited by the first region 1A. That is, the first thickness T1 of the first region 1A is smaller than the second thickness T2 of the second region 2A. Accordingly, if an overcurrent flows to the lead, the first region 1A may be heated (e.g., instantly heated) by the resistance of the lead due to the overcurrent. Accordingly, the lead may be cut off at the first region 1A. Accordingly, the overcurrent may be blocked from being transmitted to the electrode assembly 200. Accordingly, heating of the electrode assembly 200 may be prevented or substantially prevented. Accordingly, a fire of the secondary battery may be prevented or substantially prevented. Accordingly, the secondary battery according to the embodiment may have improved safety.

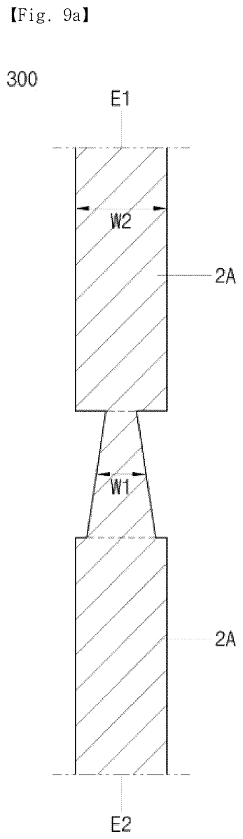

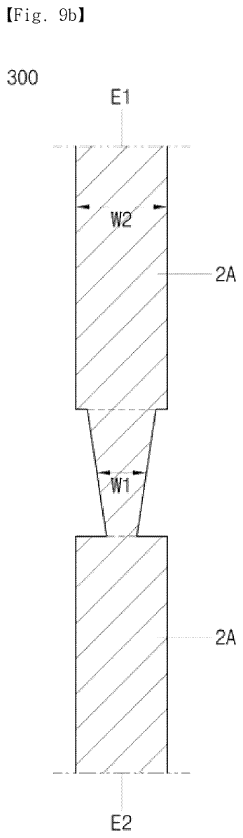

Referring to FIGS. 9A to 11, the first region 1A may have various shapes.

Referring to FIGS. 9A and 9B, in an embodiment, the first region 1A may have a first width W1. The first width W1 may vary along a direction, or while extending in the direction. For example, the first width W1 may decrease while extending from the first end E1 toward the second end E2. In another embodiment, the first width W1 may increase while extending from the first end E1 toward the second end E2.

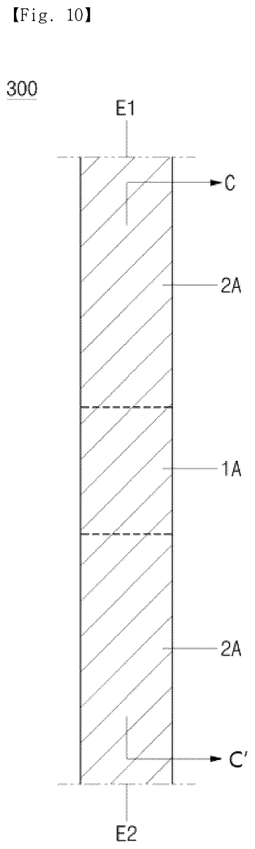

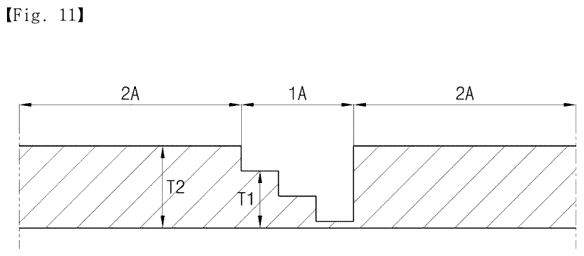

Referring to FIGS. 10 and 11, the first region 1A may have a first thickness T1. The first thickness T1 may vary while extending in a direction. For example, the first thickness T1 may decrease while extending from the first end E1 toward the second end E2. In an embodiment, the first thickness T1 may increase while extending from the first end E1 toward the second end E2.

Accordingly, the first region 1A may be short-circuited in a wide current range. That is, an allowable current range of the lead may be widened. For example, if a width of the first region is the same, the lead may be short-circuited only when a current A flows. However, if the width of the first region changes, the lead may be short-circuited at a current B to the current A (current A>current B). Accordingly, the secondary battery may be applied to various electronic devices.

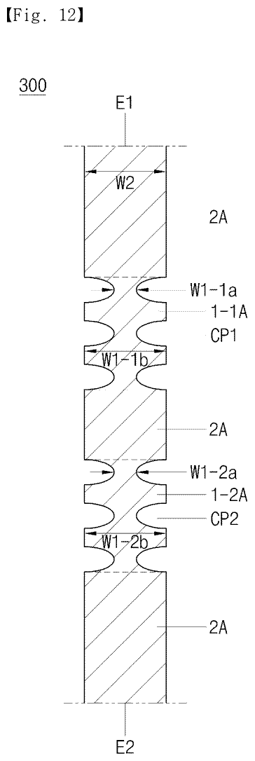

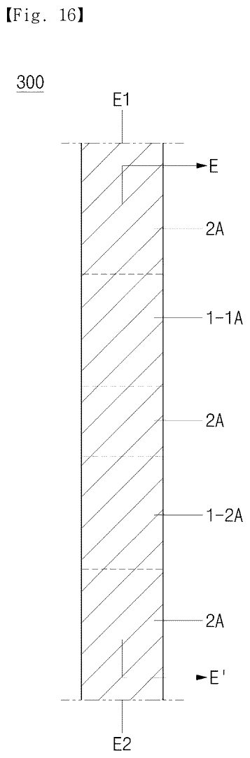

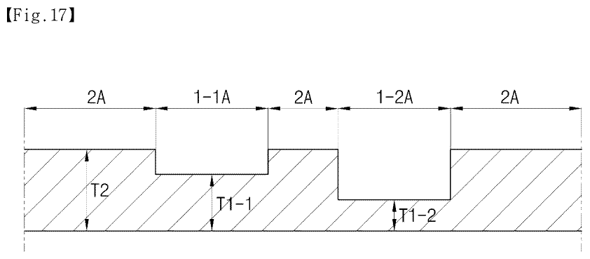

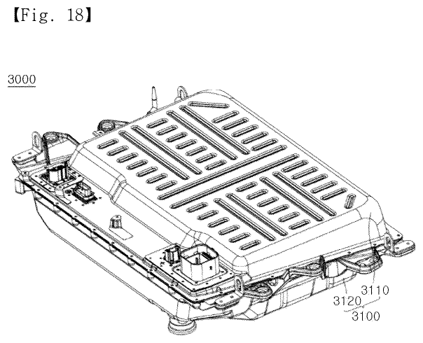

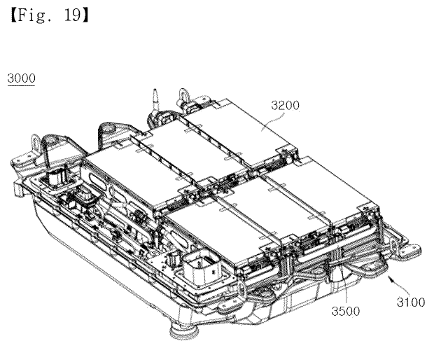

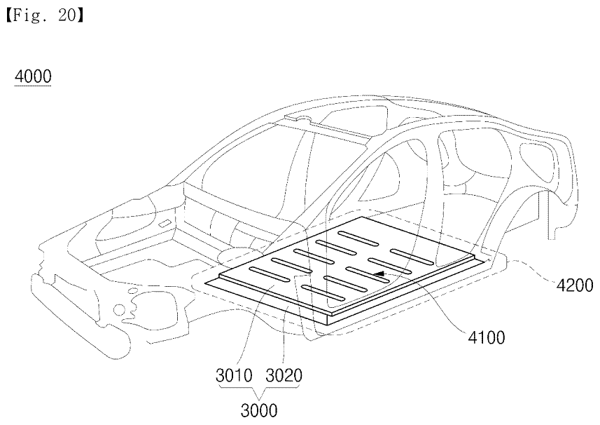

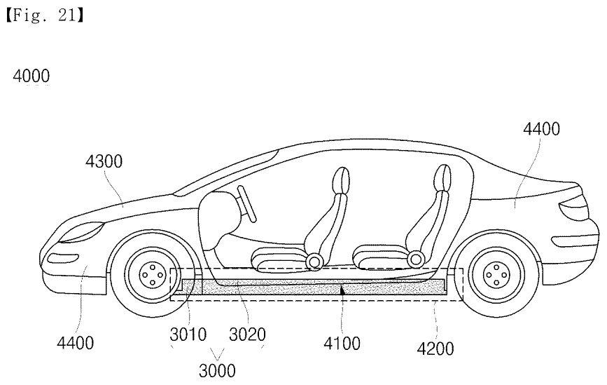

Referring to FIGS. 12 to 17, the first region 1A may include a plurality of regions.

Referring to FIG. 12, the first region 1A may include a 1-1 region 1-1A and a 1-2 region 1-2A.

The 1-1 region 1-1A may include a first cutting part CP1. The 1-2 region 1-2A may include a second cutting part CP2. Sizes of the first cutting part CP1 and the second cutting part CP2 may be the same or similar.

Accordingly, the 1-1 region 1-1A and the 1-2 region 1-2A may have same or similar sizes. For example, the 1-1 region 1-1A may have a 1-1a width W1-1a and a 1-1b width W1-1b. The 1-1a width W1-1a may be smaller than the 1-1b width W1-1b due to the first cutting part CP1. That is, the 1-1a width W1-1a may be a minimum width of the 1-1 region 1-1A, and the 1-1b width W1-1b may be a maximum width of the 1-1 region 1-1A. The 1-2 region 1-2A may have a 1-2a width W1-2a and a 1-2b width W1-2b. The 1-2a width W1-2a may be smaller than the 1-2b width W1-2b due to the second cutting part CP2. That is, the 1-2a width W1-2a may be a minimum width of the 1-2 region 1-2A, and the 1-2b width W1-2b may be a maximum width of the 1-2 region 1-2A.

In an embodiment, the 1-1b width W1-1b and the 1-2b width W1-2b may be the same as or similar to the 2 width W2. The 1-1a width W1-1a and the 1-2a width W1-2a may be smaller than the 2 width W2. In an embodiment, the 1-1a width W1-1a and the 1-2a width W1-2a may be the same or similar.

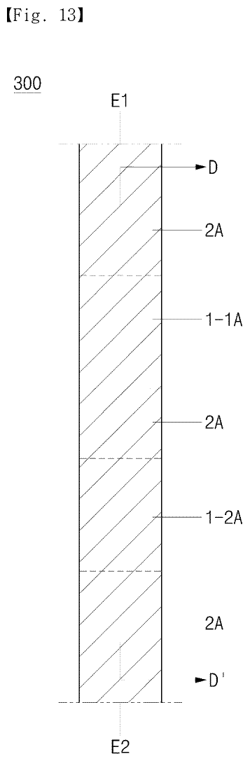

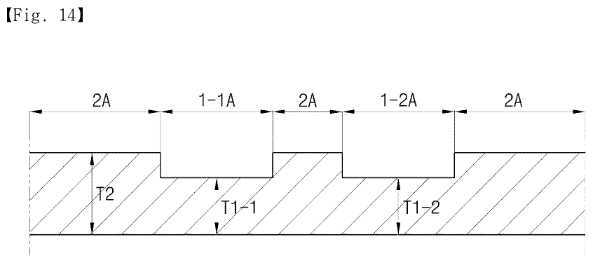

In an embodiment, referring to FIG. 13 and FIG. 14, the 1-1 region 1-1A may have a 1-1 thickness T1-1. The 1-2 region 1-2A may have a 1-2 thickness T1-2.

The 1-1 thickness T1-1 and the 1-2 thickness T1-2 may be smaller than the 2 thickness T2.

If an overcurrent flows through the lead, the first region may not be short-circuited due to the time of the overcurrent or other variables. Accordingly, the first region 1A may include a plurality of regions. The current flows from the first end E1 toward the second end E2. If an overcurrent flows through the lead, the lead may be short-circuited in the first region. At this time, the 1-1 region 1-1A may not be short-circuited due to various variables. However, the lead may be short-circuited in the 1-2 region 1-2A.

Therefore, the secondary battery according to an embodiment may prevent or substantially prevent overcurrent from being transmitted to the electrode assembly. Therefore, the secondary battery according to an embodiment may have improved safety.

Sizes of the 1-1 region 1-1A and the 1-2 region 1-2A may be different. In an embodiment, a length of the 1-1 region 1-1A and a length of the 1-2 region 1-2A may be different. For example, the length of the 1-2 region 1-2A may be shorter than the length of the 1-1 region 1-1A. Based on a direction in which the current flows, the 1-1 region 1-1A may be a main short circuit part, and the 1-2 region 1-2A may be an auxiliary short circuit part. A strength of the lead may be reduced by the 1-2 region 1-2A. Therefore, the length of the 1-2 region 1-2A, which is an auxiliary short circuit part, may be formed to be relatively short. Accordingly, damage to the lead due to an external impact may be prevented or reduced.

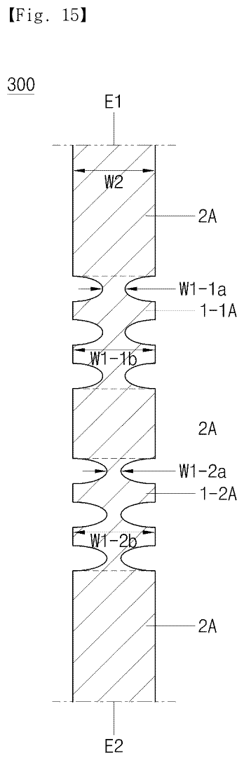

Referring to FIGS. 15 to 17, the 1-1 region 1-1A and the 1-2 region 1-2A may have different sizes.

For example, the 1-1b width W1-1b and the 1-2b width W1-2b may be the same as or similar to the 2 width W2. The 1-1a width W1-1a and the 1-2a width W1-2a may be smaller than the 2 width W2. In an embodiment, the 1-1a width W1-1a and the 1-2a width W1-2a may be different. For example, the 1-1a width W1-1a may be larger than the 1-2a width W1-2a. In an embodiment, the 1-1 thickness T1-1 may be larger than the 1-2 thickness T1-2.

Accordingly, the first region 1A may be short-circuited in a wide current range. That is, an allowable current range of the lead may be widened. For example, if the 1-1a width W1-1a and the 1-2a width W1-2a are the same, the lead may be short-circuited only when current A flows. However, since the width of the first region varies, the lead may be short-circuited at current B to current A (current A>current B). Accordingly, the secondary battery may be applied to various electronic devices.

The secondary battery according to embodiments includes the lead. The lead is connected to the external terminal and the electrode tab. Accordingly, the secondary battery transmits current to the electrode assembly through the lead and the electrode tab.

The secondary battery may flow a current exceeding an allowable current range due to overcharge or malfunction. Accordingly, the electrode assembly may be heated by the overcurrent. Accordingly, the internal temperature of the secondary battery may increase. When the electrode assembly is exposed to a high temperature environment for a long time, the electrolyte may vaporize and generate gas, and the internal pressure of the secondary battery may increase due to the gas. Accordingly, a fire in the secondary battery may occur.

The secondary battery according to embodiments includes a first region in which the width or thickness of the lead is small. Accordingly, if the overcurrent flows through the lead, the lead may be short-circuited in the first region. Accordingly, the overcurrent may be prevented or substantially prevented from being transmitted to the electrode assembly. Accordingly, a fire of the secondary battery can be prevented or substantially prevented.

In one or more embodiments, the first region may change in width while extending from the first end of the lead to the second end of the lead. Accordingly, a range of current at which the lead is short-circuited may be widened. Accordingly, the secondary battery according to embodiments may be applied to various electronic devices.

In one or more embodiments, the first region may include a plurality of first regions. Accordingly, the first region may include the main short-circuit part and the auxiliary short-circuit part. Accordingly, even if the lead is not short-circuited at the main short-circuit part, it may be short-circuited at the auxiliary short-circuit part. Accordingly, the secondary battery according to the embodiment may have improved stability.

The secondary battery described above may configure a battery module. For example, the battery module may include a plurality of secondary batteries. The plurality of secondary batteries may be connected to each other in series, in parallel, or in series/parallel by a bus bar.

What is claimed is:

1. A secondary battery comprising:
a case; and
an electrode assembly accommodated in the case,
wherein the case comprises an accommodation part and a cap part,
wherein the accommodation part and the cap part are coupled by a sealing layer,
wherein the electrode assembly comprises a first electrode, a second electrode, and a separator,
wherein the first electrode and the second electrode comprise electrode tabs,
wherein the electrode tabs are connected to a lead that is connectable to an external terminal,
wherein the lead comprises a first region and a second region,
wherein a size of the first region is smaller than a size of the second region, and
wherein the first region overlaps with the sealing layer.

2. The secondary battery as claimed in claim 1, wherein a minimum width of the first region is smaller than a width of the second region.

3. The secondary battery as claimed in claim 1, wherein a thickness of the first region is smaller than a thickness of the second region.

4. The secondary battery as claimed in claim 1, wherein a length of the first region is smaller than a length of the second region.

5. The secondary battery as claimed in claim 1, wherein a length of the first region is 5% to 10% of a length of the lead.

6. The secondary battery as claimed in claim 1, wherein the lead comprises a first end and a second end, and
wherein a width of the first region varies along a direction from the first end toward the second end.

7. The secondary battery as claimed in claim 1, wherein the lead comprises a first end and a second end, and
wherein a thickness of the first region varies along a direction from the first end toward the second end.

8. The secondary battery as claimed in claim 1, wherein the first region comprises a 1-1 region and a 1-2 region, and
wherein a minimum width of the 1-1 region and a minimum width of the 1-2 region are smaller than a width of the second region.

9. The secondary battery as claimed in claim 8, wherein lengths of the 1-1 region and the 1-2 region are different.

10. The secondary battery as claimed in claim 8, wherein the 1-2 region is located closer to the electrode assembly than the 1-1 region, and
wherein a length of the 1-2 region is smaller than a length of the 1-1 region.

11. The secondary battery as claimed in claim 8, wherein a minimum width of the 1-1 region is greater than a minimum width of the 1-2 region.

12. The secondary battery as claimed in claim 11, wherein the 1-2 region is located closer to the electrode assembly than the 1-1 region.

13. The secondary battery as claimed in claim 1, wherein the first region comprises a 1-1 region and a 1-2 region, and
wherein a thickness of the 1-1 region and a thickness of the 1-2 region are smaller than a thickness of the second region.

14. The secondary battery as claimed in claim 13, wherein the 1-2 region is located closer to the electrode assembly than the 1-1 region, and
wherein a length of the 1-2 region is smaller than a length of the 1-1 region.

15. The secondary battery as claimed in claim 13, wherein the thickness of the 1-1 region is greater than the thickness of the 1-2 region.

16. The secondary battery as claimed in claim 15, wherein the 1-2 region is located closer to the electrode assembly than the 1-1 region.

17. The secondary battery as claimed in claim 1, wherein an entirety of the first region overlaps the sealing layer.

18. The secondary battery as claimed in claim 1, wherein a portion of the first region overlaps with the sealing layer.

19. The secondary battery as claimed in claim 1, further comprising an insulating layer around the lead, and
wherein the first region entirely or partially overlaps with the insulating layer.
